(19) United States
(12) Patent Application Publication
(10) Pub. No.: US 2011/0099765 A1
(43) Pub. Date: May 5, 2011

(54) Ergonomic Handle

(76) Inventor: Kamran Youssefieh, Potomac, MD (US)

(21) Appl. No.: 12/612,926

(22) Filed: Nov. 5, 2009

(51) Int. Cl. B25G 1/10; A46B 5/00; A47L 13/20; A47L 13/52; A47L 13/16; B23P 11/00; A01B 1/02; A01D 7/00

(52) U.S. Cl. 16/430; 15/159.1; 15/147.1; 15/257.1; 15/209.1; 29/428; 294/57; 56/400.01

(57) ABSTRACT

Devices and methods are disclosed which relate to supporting a user's arm in order for the user to utilize a maintenance tool with one hand. The support wraps around the user's arm keeping the apparatus stable while in use and allowing the user to derive more power from the user's arm. A handle for the user to grasp ensures the maintenance tool does not slip up and down or rotate about the user's arm. The apparatus enables the user to simply “sweep” their arm to perform various tasks, based upon a chosen maintenance tool. The arm support extends down from the handle portion, with a maintenance tool at the end. The apparatus is extendable such that it is comfortable for different users based on their weight, weight or other factors.

### BACKGROUND OF THE INVENTION

1. Field of the Invention

The present invention relates to arm supports. More specifically, the present invention relates to arm supports for maintenance tools.

2. Background of the Invention

Cleanliness is very important to many businesses, as customers take this into account when choosing where to spend their money. Customers do not want to have to step over trash in order to fill their tank with gas, nor do they want a pile of trash near the bench they choose to rest at. Thus, businesses must sweep up or otherwise remove this trash. However, for instance, when sweeping up trash or debris, the employee must use one hand to hold a dust pan while attempting to sweep the trash or debris into the dust pan.

For example, when employees are sweeping the lot at a gas station and picking up all the cigarette butts and other trash, the employee usually has the broom in one hand and the dust pan with a handle in the other hand. This generally requires the employee to put the dust pan down, and use two hands for the broom to sweep the debris into a pile. The employee then grabs the dust pan and attempts to sweep the debris into the dust pan with one hand. Sometimes the employee puts their foot on top of the dustpan and then sweeps the debris in. However, this is not ideal or efficient, as the employee must keep bending over or uncomfortably holding the broom. The same hold true at fast food restaurants, amusement parks, etc. Such businesses often take pride in their cleanliness, with an army of employees out with brooms and dust pans cleaning up trash and debris.

Maintenance of natural conditions is another aspect of business operation. Whether raking leaves in the fall or plowing snow in the winter, employees are using tools to clear the grounds. Each of these activities and many others involve some tool attached to an extension which is held by both hands.

Employees or other users derive motion from their wrists. However, the user's arms and shoulders are better equipped to handle more physically intensive activities for longer durations.

What is needed is a way to hold and use a broom or other cleaning or maintenance device with one hand such that the other hand remains free.

### SUMMARY OF THE INVENTION

The present invention provides devices and methods for supporting a user's arm in order for the user to utilize a maintenance tool with one hand. In exemplary embodiments, the support wraps around the user's arm keeping the apparatus stable while in use and allowing the user to derive more power from the user's arm. A handle for the user to grasp ensures the maintenance tool does not slip up and down or rotate about the user's arm. The apparatus enables the user to simply “sweep” their arm to perform various tasks, based upon a chosen maintenance tool. The arm support extends down from the handle portion, with a maintenance tool at the end. The apparatus is extendable such that it is comfortable for different users based on their height, weight or other factors, and useful for different tasks.

The present invention makes maintenance, such as sweeping, raking, snow-plowing, etc., easier and more comfortable. In exemplary embodiments the apparatus is supported by the forearm of one arm, eliminating the need for two hands. Thus, the user has a hand free, enabling the user, for instance, to hold a dust pan, talk on the telephone, etc. Furthermore, the apparatus is useful for users with physical disabilities. For instance, users with only one arm are still able to easily and comfortably clean without having to awkwardly hold a maintenance tool. The apparatus is used like an extension of the arm, substantially eliminating wrist motions which may be tiresome.

In an exemplary embodiment of the present invention, the invention is a supporting apparatus for a maintenance tool. The supporting apparatus includes an arm support, a shaft having a first end coupled to the arm support, a handle coupled to the shaft near the first end, and a maintenance tool coupled with a second end of the shaft. A user's arm is inserted into the arm support so that the user's hand grasps the handle.

In another exemplary embodiment of the present invention, the invention is an arm support for a maintenance tool. The arm support includes an arm receiving member, an elongate member having a first end coupled to the arm receiving member, a handle coupled to the elongate member near the first end, and a maintenance tool coupled with a second end of the elongate member. A user's arm is inserted into the arm receiving member so that the user's hand grasps the handle.

In a further exemplary embodiment of the present invention, the invention is a method of adding an arm support to a maintenance tool having a shaft, the support having a shaft receiver. The method includes inserting a first end of the shaft into the shaft receiver, fastening the shaft to the shaft receiver, and attaching a handle to the shaft such that when a user's arm is inserted into the arm support, the user's hand grasps the handle.

### BRIEF DESCRIPTION OF THE DRAWINGS

FIGS. 1A and 1B show a support apparatus, according to an exemplary embodiment of the present invention.

FIGS. 2A, 2B, and 2C show different embodiments of a support apparatus, according to exemplary embodiments of the present invention.

FIG. 3 shows a sleeve arm support on a support apparatus, according to an exemplary embodiment of the present invention.

FIG. 4 shows a sleeve arm support on a support apparatus, according to an exemplary embodiment of the present invention.

FIGS. 5A and 5B show a cuff arm support on a support apparatus, according to an exemplary embodiment of the present invention.

FIG. 6 shows a support apparatus with a broom attachment, according to an exemplary embodiment of the present invention.

FIG. 7 shows a support apparatus with a wide broom attachment, according to an exemplary embodiment of the present invention.

FIG. 8 shows a support apparatus with a shovel attachment, according to an exemplary embodiment of the present invention.

FIG. 9 shows a support apparatus with a dust pan attachment, according to an exemplary embodiment of the present invention.

FIG. 10 shows a support apparatus with a rake attachment, according to an exemplary embodiment of the present invention.

FIG. 11 shows a support apparatus with a mop attachment, according to an exemplary embodiment of the present invention.

FIG. 12 shows a support apparatus with a duster attachment, according to an exemplary embodiment of the present invention.

FIG. 13 shows a support apparatus with a snow shovel attachment, according to an exemplary embodiment of the present invention.

FIG. 14 shows a broom having a shaft.

FIG. 15 shows a conversion kit for a support apparatus that may be attached to a maintenance tool, according to an exemplary embodiment of the present invention.

FIG. 16 shows a conversion kit attached to a shaft, according to an exemplary embodiment of the present invention.

FIG. 17 shows a support apparatus attached to a broom, according to an exemplary embodiment of the present invention.

FIGS. 18A, 18B, and 18C show different embodiments of a support apparatus, according to exemplary embodiments of the present invention.

### DETAILED DESCRIPTION OF THE INVENTION

The present invention provides devices and methods for supporting a user's arm in order for the user to utilize a maintenance tool with one hand. In exemplary embodiments, the support wraps around the user's arm keeping the apparatus stable while in use and allowing the user to derive more power from the user's arm. A handle for the user to grasp ensures the maintenance tool does not slip up and down or rotate about the user's arm. The apparatus enables the user to simply “sweep” their arm to perform various tasks, based upon a chosen maintenance tool. The arm support extends down from the handle portion, with a maintenance tool at the end. The apparatus is extendable such that it is comfortable for different users based on their height, weight or other factors, and useful for different tasks.

The present invention makes maintenance, such as sweeping, raking, snow-plowing, etc., easier and more comfortable. In exemplary embodiments the apparatus is supported by the forearm of one arm, eliminating the need for two hands. Thus, the user has a hand free, enabling the user, for instance, to hold a dust pan, talk on the telephone, etc. Furthermore, the apparatus is useful for users with physical disabilities. For instance, users with only one arm are still able to easily and comfortably clean without having to awkwardly hold a maintenance tool. The apparatus is used like an extension of the arm, substantially eliminating wrist motions which may be tiresome.

As the user has one hand free with the apparatus, the user may utilize two of the apparatus at the same time, one on each arm. For instance, a user who is cleaning up may have a broom attachment on one arm and a dust pan attachment on the other arm. This allows the user to easily sweep debris into the dust pan without having to bend down, switch hands, use two hands on the broom, etc.

In other exemplary embodiments, the apparatus is extendable such that it may be used by users of different heights, weights or other factors. For instance, when used with a broom attachment, the user may want the length of the apparatus to be such that the bristles of the broom just touch the ground when the user is slightly bent over. For a tall user this may require the apparatus to be in an extended state, while for a short user this may require the apparatus to be in a non-extended state. Embodiments of the apparatus can be extended in many ways. For example, in one embodiment, the apparatus comprises telescoping portions with a locking mechanism. This locking mechanism may be a button that is pushed when changing the height which locks when not pushed. This locking mechanism may be accomplished with a spring that pushes the button into a hole in the outer telescoping portion, etc. In another embodiment, the apparatus allows for screw-in extensions. These extensions allow the apparatus to be extendable up to the length of the extension. This may be particularly useful for adding long lengths of extensions, such as for dusting ceilings. These and other extension mechanisms, as well as combinations thereof, will become apparent to those having skill in the art in view of the present invention.

In embodiments of the present invention, each maintenance tool is an attachment. These attachments may be removed to replace the attachment with another of the same attachment or to use a different attachment. For instance, after sweeping a room the user may desire to use the apparatus for dusting. The user simply removes the broom attachment and replaces it with the dusting attachment. This may be done by twisting the attachment off, similar to the screw-in extensions, unlocked, similar to the push-button extension, etc. Various other attachments are possible for the apparatus. For instance, a snow shovel attachment, a dust pan attachment, a mop attachment, etc., are each included in different embodiments of the present invention.

The arm support of the apparatus takes many different forms. Exemplary embodiments of the arm support spiral around the user's forearm, providing support in multiple directions. The support itself is made from lightweight yet durable materials such as plastics, ceramics, wood, light metals, etc. In this type of embodiment, the support may spiral once, more than once, or even less than once around the user's forearm. The inside of the spiral, which is closest to the user's forearm, is padded in order to cushion the user's forearm from the apparatus. This may be done with foam, cloth, or other padded materials. The radius of curvature of the spirals may be any size, but ideally fits an average forearm. Alternate embodiments feature an adjustable arm support. Further embodiments of the present invention provide a sleeve to partially or fully encase the user's forearm. These embodiments provide support in all directions. Similar to spiral embodiments, these embodiments may include padding on the inside of the sleeve to protect and add comfort for the user's forearm. In other embodiments, the apparatus provides an extended shaft with a strap or cuff that wraps around a portion of the user's forearm. A cuff may gently clamp on to the user's arm while a strap may attach to the user's arm with Velcro, clips, etc. In further embodiments, the apparatus uses rigid but bendable materials, similar to those in a SNAKELIGHT, to wrap around the user's forearm. This type of material allows the user to wrap the apparatus around his or her forearm, allowing for a more snug fit for a variety of different sized forearms. The adjustability of these embodiments makes them ideal for situations in which many users use the same apparatus.

A “maintenance tool”, as used herein and throughout this disclosure, refers to a device for manual labor. Particularly useful for the present invention are devices which have a long handle to serve as an extension of the arms. Examples of devices for manual labor include brooms, mops, shovels, dusters, snow-shovels, rakes, paint rollers, etc.

For the following description, it can be assumed that most correspondingly labeled structures across the figures (e.g., 132 and 232, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

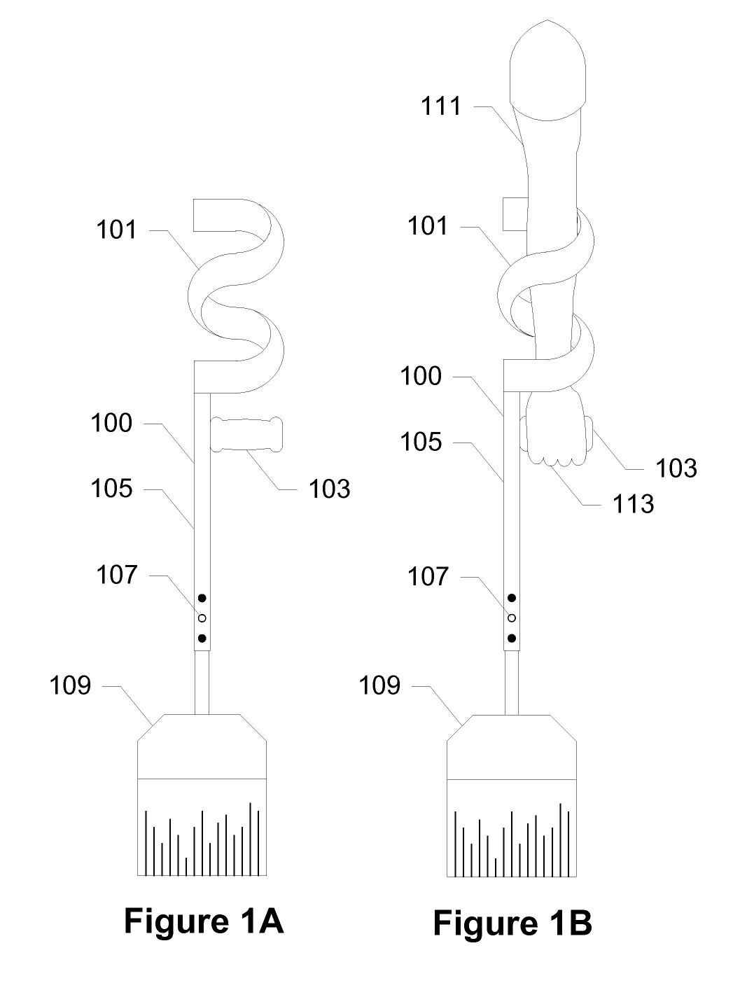

FIGS. 1A and 1B show a support apparatus 100, according to an exemplary embodiment of the present invention. In this embodiment, support apparatus 100 includes an arm support 101, a handle 103, a shaft 105, an adjustment mechanism 107, and a maintenance tool 109. Arm support 101 curves around an arm 111 of a user. Arm support 101 allows the user to sweep the maintenance tool with arm 111 while minimizing movement of the wrist with respect to the forearm. Arm support 101 includes a cushioning material such that arm support 101 does not rub against arm 111 or otherwise make arm 111 uncomfortable. When sweeping, for instance, if the user is sweeping to the left, then the right side of arm support 101 pushes against arm 111. This adds stability to the sweeping motion and allows the user to sweep with just one arm. Support apparatus 100 is used like an extension of arm 111. Handle 103 is an extension from shaft 105 which the user may grasp to prevent support apparatus 100 from rotating about arm 111. Handle 103 may be encompassed by a cushioning material to enhance the comfort of handle 103. Handle 103 may be an ergonomic shape to fit user's hand 113. Shaft 105 is composed of a rigid material, such as metal, plastic, wood, etc. Shaft 105 provides a length from the user's arm 111 to attached maintenance tool 109. Shaft 105 includes adjustment mechanism 107 such that support apparatus 100 is the appropriate length for the user and task. In this embodiment, adjustment mechanism 107 is composed of telescoping rods. The outer rod has a plurality of holes capable of receiving a locking peg. The locking peg is coupled to the inner rod and is pushed outward by a spring or other device. By pushing in the locking peg and pushing the inner rod in or pulling the inner rod out from the outer rod, the user may change the length of shaft 105. This allows support apparatus 100 to be used by a multitude of different users for a variety of tasks. Maintenance tool 109 may be a broom, dust pan, snow shovel, mop, duster, etc. Attached maintenance tool 109 extends from the end of shaft 105 below adjustment mechanism 107. Maintenance tool 109 may be replaceable such that may be put on or taken off.

In further embodiments of the present invention, the adjustment mechanism is a screw-in portion. To use this type of adjustment mechanism, the user unscrews the male end of the shaft from the maintenance tool attachment. The user inserts the male end of the shaft into the female end of the screw-in portion and the male end of the screw-in portion into the maintenance tool attachment. This screw-in portion may be any length such that the support apparatus may be used by different users and for different tasks.

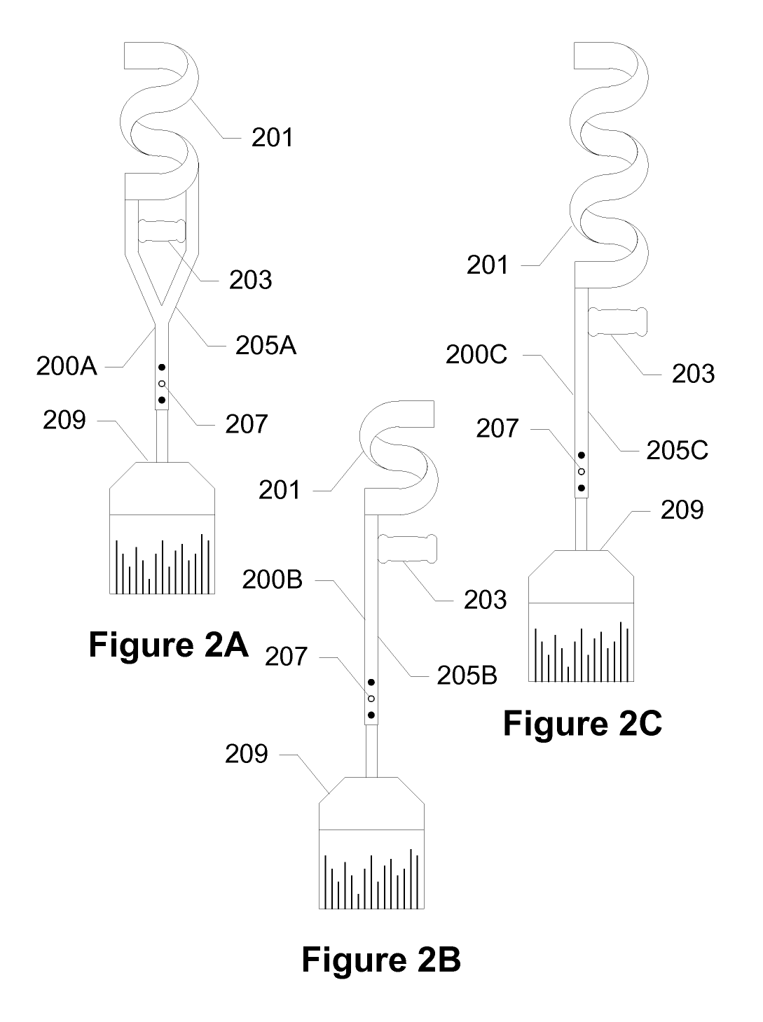

FIGS. 2A, 2B, and 2C show different embodiments of a support apparatus 200A, 200B, 200C, according to exemplary embodiments of the present invention. In these embodiments, arm support 201 curves or coils one or more times around in order to provide more or less support points against the user's arm. Additionally, the shaft of the support apparatus may take different forms.

FIG. 2A shows a support apparatus 200A with a shaft 205A similar to a crutch, according to an exemplary embodiment of the present invention. In this embodiment, support apparatus 200A includes an arm support 201, a handle 203, a shaft 205A, an adjustment mechanism 207, and a maintenance tool 209. Arm support 201 spirals around one and a half times. This provides for more than one support point where arm support 201 will brace against the user's arm during, for instance, sweeping. More spirals in arm support 201 provide more support points, but also add weight to support apparatus 200A. Thus, an ideal number of spirals may depend upon the task to be accomplished. Handle 203, when held by the user's hand, prevents support apparatus 200A from rotating about the user's arm or sliding along the user's forearm. Shaft 205A attaches to handle 203 in two places. This adds more rigidity to the handle, as may be desired for certain uses. Adjustment mechanism 207 allows the user to adjust the length of shaft 205A based upon the user and the use. Attached maintenance tool 209 couples to shaft 205A to allow the use of maintenance tool 209, such as for routine maintenance.

FIG. 2B shows a support apparatus 200B with a shaft 205B that is straight, according to an exemplary embodiment of the present invention. In this embodiment, support apparatus 200B includes an arm support 201, a handle 203, a shaft 205B, an adjustment mechanism 207, and a maintenance tool 209. Arm support 201 spirals around one time. This provides for at least one support point where arm support 201 will brace against the user's arm during use. More spirals in arm support 201 provide more support points, but also add weight to support apparatus 200B. Thus, an ideal number of spirals may depend upon the task to be accomplished. Handle 203, when held by the user's hand, prevents support apparatus 200B from rotating about the user's arm during use or sliding along the user's forearm. Handle 203 attaches to shaft 205B on one end of handle 203. Adjustment mechanism 207 allows the user to adjust the length of shaft 205B based upon the user and the use. Attached maintenance tool 209 couples to shaft 205B to allow the use of maintenance tool 209, such as for routine maintenance.

FIG. 2C shows a support apparatus 200C with a shaft 205C that is substantially straight, according to an exemplary embodiment of the present invention. In this embodiment, support apparatus 200C includes an arm support 201, a handle 203, a shaft 205C, an adjustment mechanism 207, and a maintenance tool 209. Arm support 201 spirals around two times. This provides for more than one support point where arm support 201 will brace against the user's arm. More spirals in arm support 201 provide more support points, but also add weight to support apparatus 200C. Thus, an ideal number of spirals may depend upon the task to be accomplished. Handle 203, when held by the user's hand, prevents support apparatus 200C from rotating about the user's arm or sliding along the user's forearm. Handle 203 attaches to shaft 205C at one end of handle 203. Adjustment mechanism 207 allows the user to adjust the length of shaft 205C based upon the user and the use. Attached maintenance tool 209 couples to the shaft to allow the use of maintenance tool 209, such as for routine maintenance.

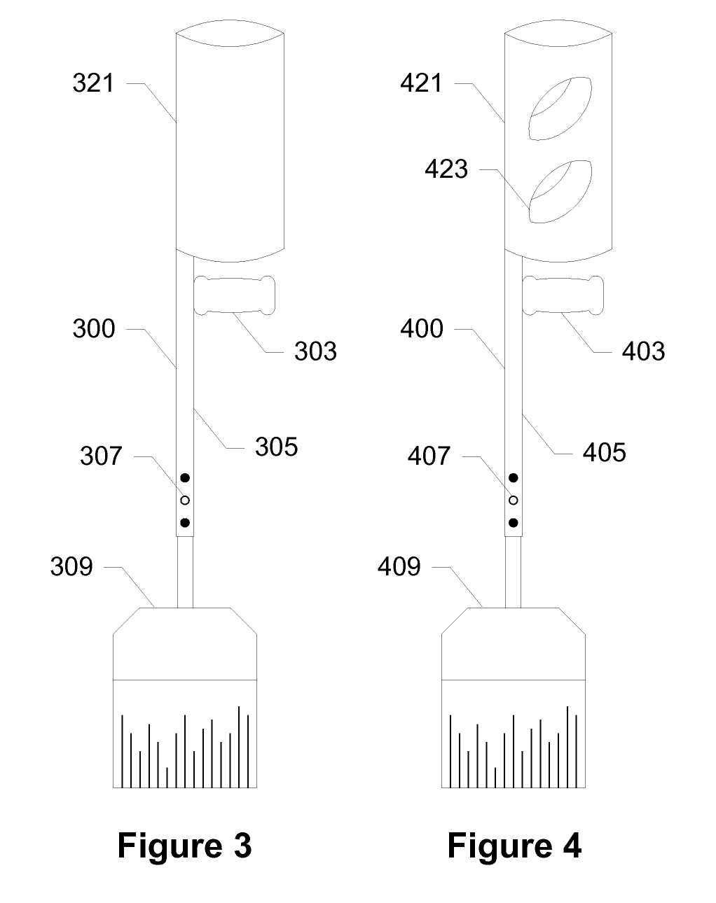

FIG. 3 shows a sleeve arm support 321 on a support apparatus 300, according to an exemplary embodiment of the present invention. In this embodiment, support apparatus 300 includes sleeve arm support 321, a handle 303, a shaft 305, an adjustment mechanism 307, and a maintenance tool 309. Sleeve arm support 321 is a cylindrical shape, open at the top and bottom for receiving the user's arm. The inside of sleeve arm support 321 may be cushioned to provide comfort to the user. Sleeve arm support 321 provides support and contact points along the full length of sleeve arm support 321. Sleeve arm support 321 is positioned such that the user may grip handle 303 to prevent sleeve arm support 321 from rotating about the user's arm or from sliding along the user's arm.

FIG. 4 shows a sleeve arm support 421 on a support apparatus 400, according to an exemplary embodiment of the present invention. In this embodiment, sleeve arm support 421 includes a plurality of vents 423. These vents 423 may provide airflow to keep the forearm of the user cool. Support apparatus 400 includes sleeve arm support 421, a handle 403, a shaft 405, an adjustment mechanism 407, and a maintenance tool 409. Sleeve arm support 421 is a cylindrical shape, open at the top and bottom for receiving the user's arm. Sleeve arm support 421 also includes vents 423 located on sides of the cylinder. Vents 423 may be of any shape or size. The inside of sleeve arm support 421 may be cushioned to provide comfort to the user. Sleeve arm support 421 provides support and contact points along the full length of sleeve arm support 421. Sleeve arm support 421 is positioned such that the user may grip handle 403 to prevent sleeve arm support 421 from rotating about the user's arm or from sliding along the user's arm.

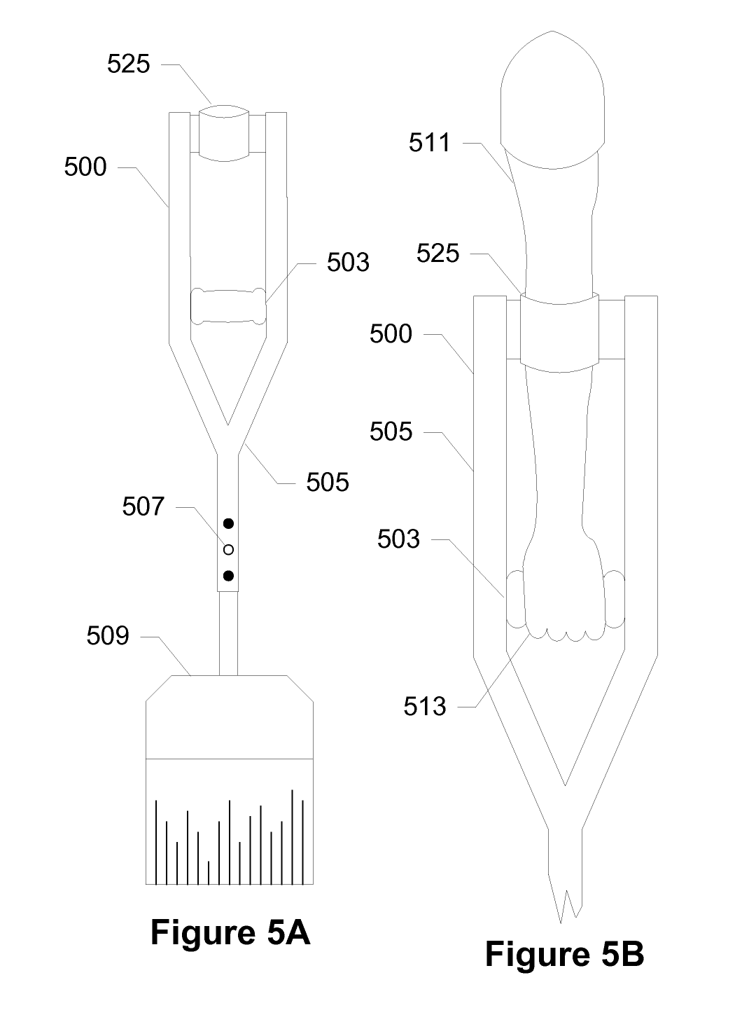

FIGS. 5A and 5B show a cuff arm support 525 on a support apparatus 500, according to an exemplary embodiment of the present invention. In this embodiment, support apparatus 500 includes cuff arm support 525, a handle 503, a shaft 505, an adjustment mechanism 507, and a maintenance tool 509. Cuff arm support 525 is a cylindrical shape, open at the top and bottom for receiving the user's arm. Cuff arm support 525 may have an opening on one side of the cylinder such that cuff arm support 525 clamps on to a user's arm 511. The inside of cuff arm support 525 may be cushioned to provide comfort to the user. Cuff arm support 525 provides support and contact points along the length of cuff arm support 525. Cuff arm support 525 is centered such that the user may grip handle 503 with hand 513 to prevent cuff arm support 525 from rotating about user's arm 511 or from sliding along user's arm 511. In this embodiment, user's arm 511 fits in between a split shaft 505.

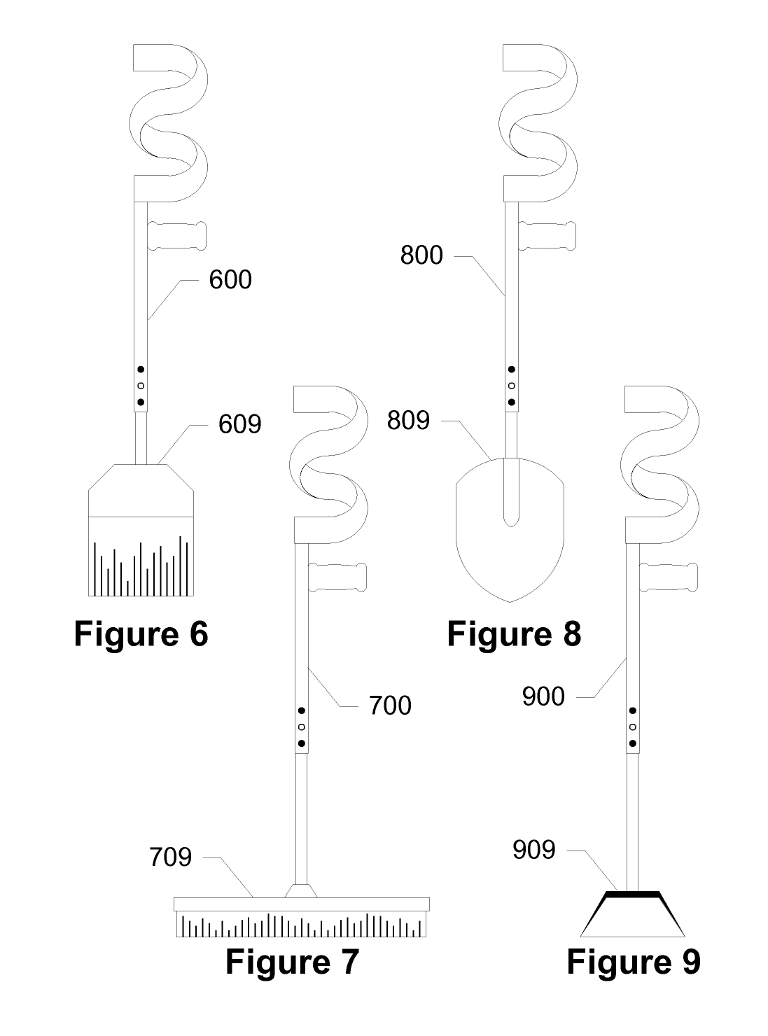

FIGS. 6-13 show embodiments of the present invention utilizing different maintenance tool attachments. While maintenance tools are used in these embodiments, other attachments are also possible. The support apparatus allows for one hand operation of tools, etc.

FIG. 6 shows a support apparatus 600 with a broom attachment 609, according to an exemplary embodiment of the present invention. In this embodiment, broom attachment 609 allows a user to sweep only using one hand/arm with back and forth motions, side to side motions, etc.

FIG. 7 shows a support apparatus 700 with a wide broom attachment 709, according to an exemplary embodiment of the present invention. In this embodiment, wide broom attachment 709 allows a user to sweep an area by pushing, pulling, etc.

FIG. 8 shows a support apparatus 800 with a shovel attachment 809, according to an exemplary embodiment of the present invention. In this embodiment, shovel attachment 809 allows a user to dig and lift dirt, debris, etc. with one arm.

FIG. 9 shows a support apparatus 900 with a dust pan attachment 909, according to an exemplary embodiment of the present invention. In this embodiment, a user can hold support apparatus 900 with one hand/arm and sweep into dust pan attachment 909. With a second support apparatus on the user's other arm, the user can use one arm to sweep while collecting debris with dust pan attachment 909 being controlled by the user's other arm.

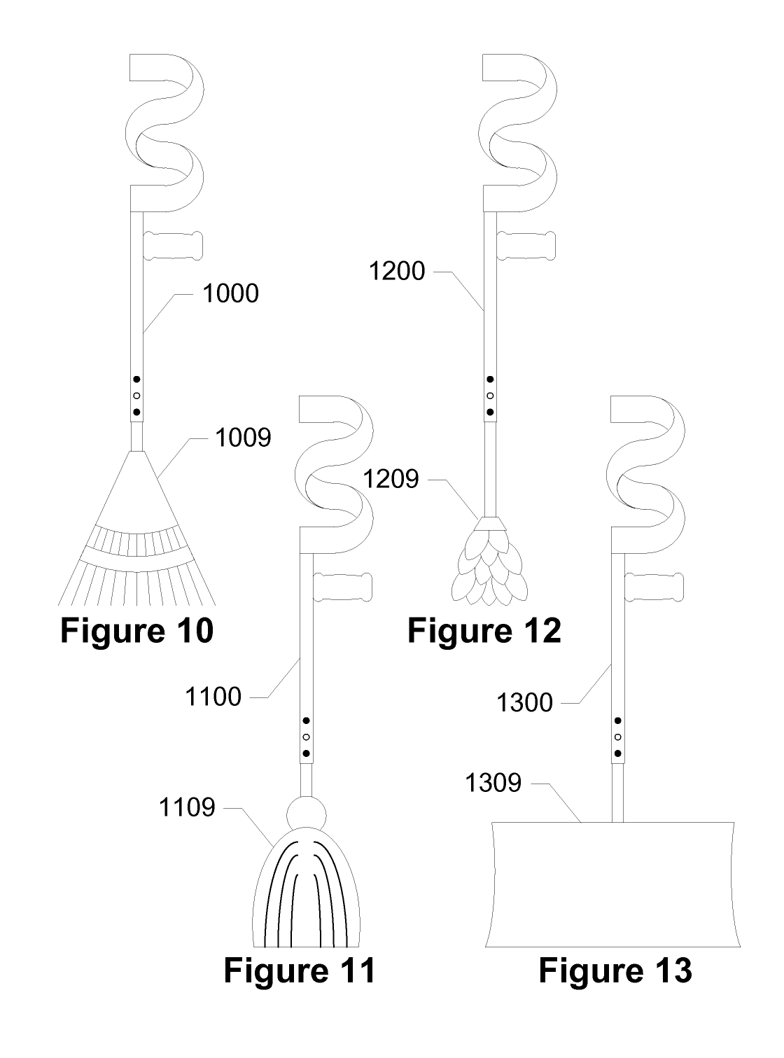

FIG. 10 shows a support apparatus 1000 with a rake attachment 1009, according to an exemplary embodiment of the present invention. In this embodiment, a user can rake leaves, debris, etc. with rake attachment 1009 using back and forth motions, side to side motions, etc.

FIG. 11 shows a support apparatus 1100 with a mop attachment 1109, according to an exemplary embodiment of the present invention. In this embodiment, a user can mop a floor using back and forth motions, side to side motions, circular motions, etc.

FIG. 12 shows a support apparatus 1200 with a duster attachment 1209, according to an exemplary embodiment of the present invention. Duster attachment 1209 allows a user to reach locations, such as a ceiling fan, only using one arm. Support apparatus 1200 may be extended to reach these areas.

FIG. 13 shows a support apparatus 1300 with a snow shovel attachment 1309, according to an exemplary embodiment of the present invention. In this embodiment, a user can shovel snow with one arm. The user can push the shovel forward and lift the shovel and snow. Support apparatus 1300 supports the force from each direction against the user's arm.

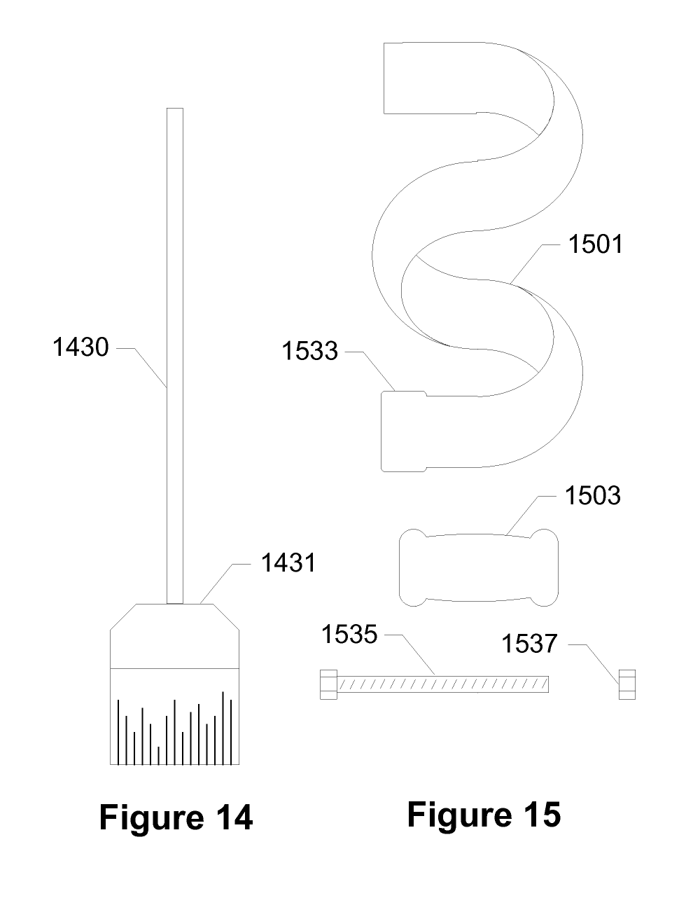

FIGS. 14 and 15 show a broom having a shaft and a support apparatus that may be attached to the broom, according to an exemplary embodiment of the present invention. In this embodiment, the present invention is a conversion kit containing an arm support 1501, a handle 1503, a bolt 1535, and a nut 1537. A shaft 1430 of the broom is inserted into a shaft receiver 1533 of arm support 1501, with the appropriate length of stick 1430 inserted such that the broom is an appropriate length for the user. Shaft receiver 1533 is then tightened around shaft 1430. The tightening may be accomplished with a screw, bolt, clamp, etc. Handle 1503 is attached to shaft 1430 using bolt 1535 and nut 1537. In embodiments this requires creating a hole in shaft 1430. A handle clamp may also be used for attaching handle 1503. Broom attachment 1431 is used similar to attached maintenance tools seen in the previous embodiments. In further embodiments, broom attachment 1431 may be removed and replaced with a different maintenance tool, such as one of the attachments seen in FIGS. 6-13.

In alternate embodiments, the conversion kit comes with a sleeve arm support. The sleeve may come with air vents or may be solid allowing the user to make custom air vents. Other fasteners, such as nails, screws, rivets, etc., may be used to attach the handle to the shaft of the maintenance tool. Once the shaft has been inserted into the shaft receiver it may be beneficial to sever any excess length of shaft. This is ideal when the conversion kit is used as a permanent feature. However, the conversion kit does not have to be permanent, and some embodiments allow for normal operation without the excess shaft severed.

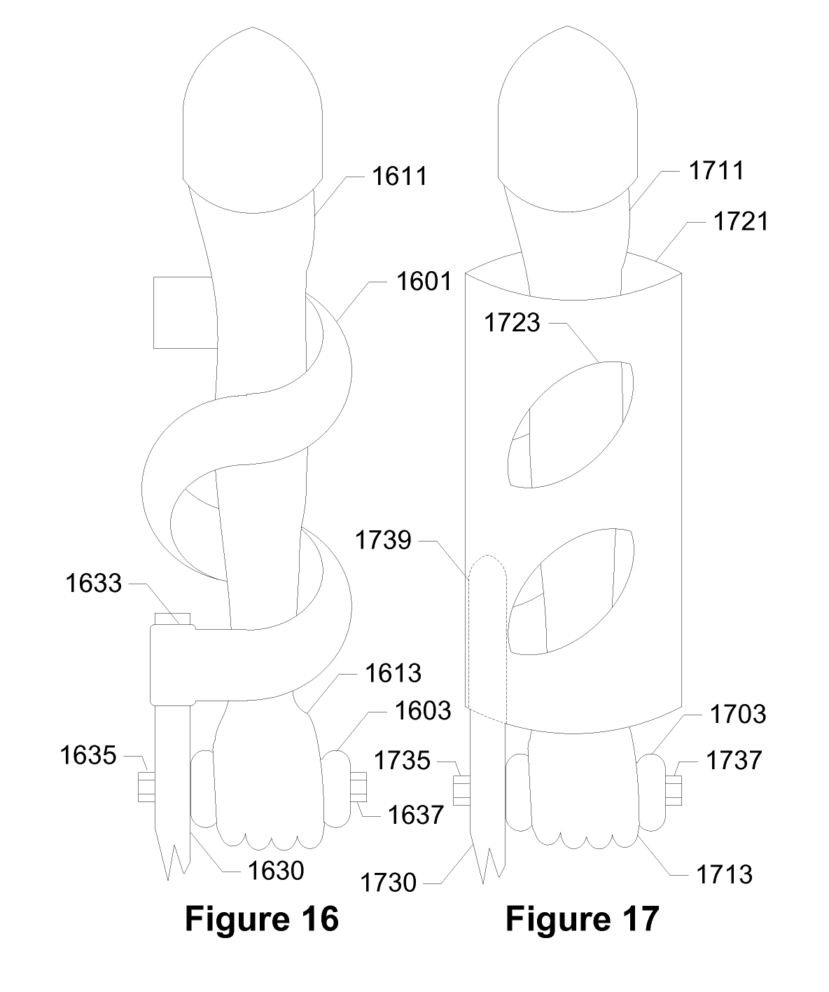

FIG. 16 shows a conversion kit attached to a shaft, according to an exemplary embodiment of the present invention. In this embodiment, a shaft 1630 of a broom has been inserted into a shaft receiver 1633 on an arm support 1601 and a handle 1603 has been attached to shaft 1630 using a bolt 1635 and a nut 1637. A user can grasp handle 1603 in a hand 1613 with an arm 1611 inserted in arm support 1601. This supports shaft 1630 and any attachment with arm 1611 of the user. Hand 1613 gripping handle 1603 prevents arm support 1601 from rotating around arm 1611. Hand 1613 gripping handle 1603 also prevents arm support 1601 from moving up and down arm 1611 such that arm support 1601 is stable and comfortable.

FIG. 17 shows a support apparatus attached to a broom, according to an exemplary embodiment of the present invention. In this embodiment, the arm support is a sleeve arm support 1721 with vents 1723. A shaft 1730 of a broom slides into a receiving portion 1739 of sleeve arm support 1721. Receiving portion 1739 clamps or otherwise attaches to shaft 1730. Receiving portion 1739 is positioned such that shaft 1730 does not interfere with an arm 1711 of the user. A handle 1703 is attached to shaft 1730 using a bolt 1735 and a nut 1737 or may clamp on to shaft 1730. By holding handle 1703 with a hand 1713, the user prevents sleeve arm support 1721 from rotating about arm 1711 or sliding up and down arm 1711.

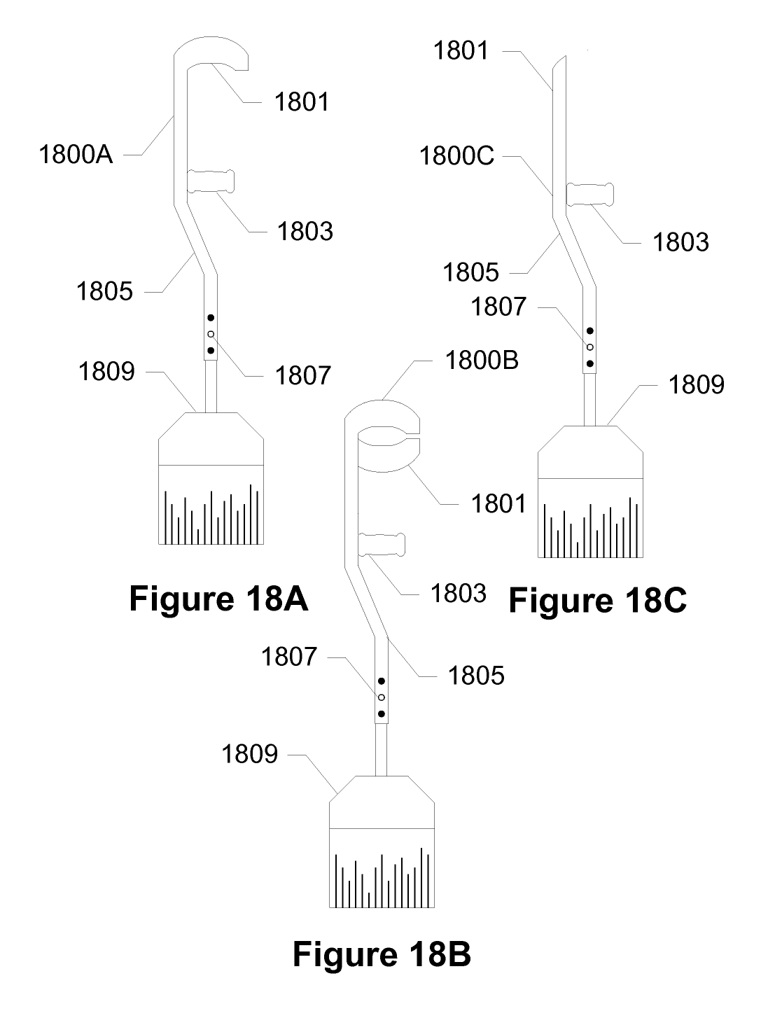

FIGS. 18A, 18B, and 18C show different embodiments of a support apparatus, according to exemplary embodiments of the present invention. In these embodiments, arm support 201 curves or coils one or more times around in order to provide more or less support points against the user's arm. Additionally, the shaft of the support apparatus may take different forms.

FIGS. 18A, 18B, and 18C show different embodiments of a support apparatus 1800A, 18008, 1800C, according to exemplary embodiments of the present invention. In these embodiments, the arm support is generally straight such that it runs along a user's arm. Support apparatus 1800A, 1800B, 1800C provides a cuff, contour, etc. in order to provide more or less support points or a larger surface against the user's arm.

FIG. 18A shows a support apparatus 1800A with a contoured arm support 1801, according to an exemplary embodiment of the present invention. In this embodiment, support apparatus 1800A includes arm support 1801, a handle 1803, a shaft 1805, an adjustment mechanism 1807, and a maintenance tool 1809. Arm support 1801 is relatively straight above the point where handle 1803 attaches. Arm support 1801 may be shorter than other embodiments, using less material such that arm support 1801 braces against the user's forearm. The top of arm support 1801 preferably provides a curved surface such that it comfortably braces the contour of the user's arm, such as at the forearm of the user. This provides for a relatively wide support point where arm support 1801 braces against the user's arm during, for instance, sweeping. Handle 1803, when held by the user's hand, prevents support apparatus 1800A from rotating about the user's arm or sliding along the user's forearm. Handle 1803 is coupled to shaft 1805 using a clip, bolt, screw, adhesive, etc. Adjustment mechanism 1807 allows the user to adjust the length of shaft 1805 based upon the user and the use. Attached maintenance tool 1809 couples to shaft 1805 to allow the use of maintenance tool 1809, such as for routine maintenance.

FIG. 18B shows a support apparatus 1800B with a cuff arm support 1801, according to an exemplary embodiment of the present invention. In this embodiment, support apparatus 1800A includes cuff arm support 1801, a handle 1803, a shaft 1805, an adjustment mechanism 1807, and a maintenance tool 1809. Cuff arm support 1801 is relatively straight above the point where handle 1803 attaches until the point where the cuff begins. The cuff of cuff arm support 1801 substantially surrounds the forearm of the user to provide support. This provides for a relatively wide support point where cuff arm support 1801 braces against the user's arm during, for instance, sweeping. Cuff arm support 1801 may be shorter than other embodiments, using less material such that cuff arm support 1801 braces against the user's forearm. Handle 1803, when held by the user's hand, prevents support apparatus 18008 from rotating about the user's arm or sliding along the user's forearm. Handle 1803 is coupled to shaft 1805 using a clip, bolt, screw, adhesive, etc. Adjustment mechanism 1807 allows the user to adjust the length of shaft 1805 based upon the user and the use. Attached maintenance tool 1809 couples to shaft 1805 to allow the use of maintenance tool 1809, such as for routine maintenance.

FIG. 18C shows a support apparatus 1800C with an arm support 1801 that is substantially straight, according to an exemplary embodiment of the present invention. In this embodiment, support apparatus 1800C includes arm support 1801, a handle 1803, a shaft 1805, an adjustment mechanism 1807, and a maintenance tool 1809. Arm support 1801 is relatively straight above the point where handle 1803 attaches. Arm support 1801 may be shorter than other embodiments, using less material such that arm support 1801 braces against the user's forearm. The top of arm support 1801 preferably provides a wider surface than shaft 1805 such that arm support 1801 comfortably braces the forearm of the user. This provides for a relatively wide support point where arm support 1801 braces against the user's arm during, for instance, sweeping. Handle 1803, when held by the user's hand, prevents support apparatus 1800C from rotating about the user's arm or sliding along the user's forearm. Handle 1803 is coupled to shaft 1805 using a clip, bolt, screw, adhesive, etc. Adjustment mechanism 1807 allows the user to adjust the length of shaft 1805 based upon the user and the use. Attached maintenance tool 1809 couples to shaft 1805 to allow the use of maintenance tool 1809, such as for routine maintenance.

In alternate embodiments of a conversion kit a flange extends from the arm support toward the maintenance tool along the shaft. A handle is attached to the flange such that it extends perpendicular to the shaft. The handle is within grasping distance of the user's hand. In these embodiments the conversion is complete when the shaft is attached to the receiving portion.

All of the aforementioned combinations should be customizable to suit the user. In some cases it may even be advantageous to provide device modifications suited to various disabilities and/or missing fingers or limbs: thus improving the usefulness of the device for the largest possible user base.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A supporting apparatus for a maintenance tool, comprising:
an arm support;
a shaft having a first end coupled to the arm support;
a handle coupled to the shaft near the first end; and
a maintenance tool coupled with a second end of the shaft;
wherein a user's arm is inserted into the arm support so that the user's hand grasps the handle.

2. The apparatus in claim 1, wherein the arm support is a sleeve.

3. The apparatus in claim 2, wherein the sleeve has air vents.

4. The apparatus in claim 1, wherein the arm support is a coil.

5. The apparatus in claim 4, wherein the coil is made from a material flexible enough to bend to fit around the user's arm, yet strong enough to hold its position during use.

6. The apparatus in claim 1, wherein the arm support is a cuff.

7. The apparatus in claim 1, wherein the second end of the shaft is centered with the handle.

8. The apparatus in claim 1, further comprising a shaft length adjuster near the second end of the shaft.

9. The apparatus in claim 1, wherein the maintenance tool is one of a broom, mop, shovel, dust pan, rake, duster, and snow plow.

10. An arm support device for a maintenance tool, comprising:
an arm receiving member;
an elongate member having a first end coupled to the arm receiving member;
a handle coupled to the elongate member near the first end; and
a maintenance tool coupled with a second end of the elongate member,
wherein a user's arm is inserted into the arm receiving member so that the user's hand grasps the handle.

11. The device in claim 10, wherein the arm receiving member is a hollow cylinder.

12. The device in claim 11, wherein the hollow cylinder has ventilation holes.

13. The device in claim 10, wherein the arm receiving member is a coil.

14. The device in claim 13, wherein the coil is made from a material flexible enough to bend to fit around the user's arm, yet strong enough to hold its position during use.

15. The device in claim 10, wherein the arm receiving member wraps around a user's forearm.

16. The device in claim 10, further comprising a shaft length adjuster near the second end of the elongate member.

17. The device in claim 10, wherein the maintenance tool is one of a broom, mop, shovel, dust pan, rake, duster, and snow plow.

18. A method of adding an arm support to a maintenance tool having a shaft, the support having a shaft receiver, comprising:
inserting a first end of the shaft into the shaft receiver;
fastening the shaft to the shaft receiver; and
attaching a handle to the shaft such that when a user's arm is inserted into the arm support, the user's hand grasps the handle.

19. The method in claim 18, further comprising removing a portion of the shaft extending from the first end of the shaft to the shaft receiver.

20. The method in claim 18, wherein the fastening includes removably fastening the shaft to the shaft receiver.
